(19) United States
(12) Patent Application Publication
(10) Pub. No.: US 2003/0084101 A1
(43) Pub. Date: May 1, 2003

(54) Selective distribution of electronic files via a common access platform

(76) Inventor: Tin Cheung Wong, Kowloon (HK)

Correspondence Address: CLARK & BRODY, Suite 600, 1750 K Street, Washington, DC, 20006, US

(21) Appl. No.: 09/985,029

(22) Filed: Nov. 1, 2001

(51) Int. Cl. G06F 15/16

(52) U.S. Cl. 709/204; 709/223

(57) ABSTRACT

A system for the distribution of electronic documents and information to multiple participants in a project hosting web site using a multiple account, multiple administrator platform such that each participant can distribute its files and or data to all other participants or selectively distribute its files and or data to selected participants. Each participant is provided with an individual platform which is linked to all other platforms on the server and which is self administered by each participant and which exists as a component of the project workspace. By maintaining a discrete and secure platform each participant receives its own individual copy of the electronic files and or data for document management, archival and internal circulation.

This invention relates to a system for the selective distribution of electronic files across a common access Internet based platform.

In any construction project, there exists numerous parties involved in its execution such as the developer, architect, engineer, main contractor, nominated subcontractor, direct subcontractor and supplier. Such projects inevitably generate a huge volume of documentation such as letters, drawings, photographs, site instructions and so on. Documents are generated on a daily basis, drawings are revised, plans and designs are amended and so on. In order for the project to proceed smoothly, it is vital that all relevant documentation and information reaches the relevant parties.

The nature of a construction project is highly dynamic and changes take place constantly throughout the course of the project. Any changes or revisions, whether major or minor, have to be recorded and approved by all relevant parties, as they will impact on the contractual obligations between one or more of the parties. It is thus vital to ensure that all revisions and instructions are promptly sent to the different parties for their action. Very often the same document or instruction has to be sent to numerous companies participating within the contract, as well as to multiple individuals within each company.

Prior to the advent of the Internet, communications between multiple parties relied on physical copies of the relevant documents being sent to the appropriate parties. This system for the dissemination and distribution of information is fraught with problems such as filing of large volume of documents, ensuring rapid access to up to date information, ensuring all relevant documents reach the appropriate parties and the sheer logistics behind the delivery of such a large amount of information to varying locations. Further disadvantages of the manual system for distribution of documents is that documents can often be misfiled, mislaid or simply lost in transit.

It is not unusual for different parties on a project to be located in different countries and so the issue of distribution and circulation of documents becomes further exacerbated. Often the usual means of distribution such as faxes and couriers are not good enough or too slow. Thus for example if the company preparing the drawings is based overseas it can become difficult for drawings to be sent back and forth to effect revisions and changes. Often the only practical way to send such drawings is by courier. This not only gives rise to escalating costs but can also add to delays in finalizing the drawings.

Such logistical problems have to some extent been addressed by the advent of the Internet. The Internet provided a common access platform for the parties to the project to distribute and access information. Such common access platforms have evolved in the project hosting type web-sites, which are typically single account, singular ultimate administrator platforms.

In this type of common access platform typically the developer will contract with a service provider to provide the software and hardware to host the project website. The service provider will then allocate the developer with space on its server together and set up the necessary software to enable documents to be uploaded to and downloaded from the server and managed. The site will usually be administered by a person from the developer and this person will have overall responsibility for maintaining the integrity of the site.

Typically such project hosting sites allow all parties to have access to the same, single copy of documentation. Thus, if one of the parties wishes to provide some instructions or send a document to the other parties it would upload the relevant file in an electronic format to the server. Once the file is on the server, it is then available to all parties who have the necessary security clearance for that project at that level. Thus, by providing common access it is possible for all parties to have access to the same information.

Such systems have enabled parties to distribute and disseminate information and documents much faster and more efficiently regardless of where the parties are physically located. Hence, for example, all engineering drawings may be uploaded to the common access platform on the server allowing the architects to then revise and amend drawings as necessary and upload the revisions to the server in a fraction of the time compared to the manual method prior to the Internet.

This system works well in theory in that it enables all parties to have access to the same information through a single access point. In practice, however, there are practical problems inherent with this system. The virtue of the common access platform system for distribution of information is also its principal draw back in that potentially all parties have access to the information which is uploaded to the server.

With these types of platforms there is usually one party with ultimate responsibility for administering access to the platform. Invariably, the administrator will be a staff member of one of the participating companies. This party will therefore have access to and control over all information on the server, regardless of whether it is entitled to the information or not.

Different parties in a project may not, for legal, contractual, confidential or other reasons, wish to disclose some or all of its information to the other parties on the project. For example, the main contractor may wish to communicate with their subcontractor without the client/architect being aware of or privy to such communication. Also, the document filing system must be standardised for all parties, giving little room for each party to perform customised document management on a company basis.

In such circumstances an open platform allowing all parties to have access to all information relating to a project acts as a disincentive for the parties to use the open platform.

The present invention seeks to overcome this disadvantage with the open platform by allowing the various parties to be able to selectively circulate documents and confidential information in an electronic format using an open platform on the Internet.

The present invention relates to a method of selective distribution of electronic files via a common access platform whereby a user can use an Internet based platform and at the same time ensure that its files can only be accessed by selective parties. The system to enable the selective distribution of information and documentation between the various parties requires the creation of a multiple account, multiple administrator platform. In such a system an individual platform is created for each participant in the venture, which is self-administered and which exists as a component of the project workspace.

In such a system documents that are to be made available to all the parties are automatically uploaded on each companies' platform, however documents that are to be distributed selectively are directed only to the other component platforms in the project workspace specified by the sender. By maintaining a secure, discrete platform each participant on the project will possess its own individual copy of the data for document management, archival and internal circulation reasons as opposed to one common data file only available through the common access platform.

By maintaining internal circulation within a users own discrete platform the user is able to ensure any comments/feedback received in relation to any particular data are not available to any other user as they would be on an open platform. Hence the user can maintain confidentiality in respect of all internal comments.

Thus for example if company A wishes to send a document to company B and C, but not to company D then it would upload the data to the server specifying company B and C as the recipients. The data would then be directed to the platform for company B and C only. In this manner selective distribution of the data can be achieved. This system thus facilitates and encourages the parties to use the common access platforms for selective distribution of open and confidential files, reports and other such project related information.

### METHOD OF OPERATION

The system for selective distribution of electronic files requires the establishment of a server to which all parties can have access. There is provided on the server a facility for each individual participating company to establish and maintain its own platform i.e. its own distinct space on the server. This platform is controlled exclusively by that company's own administrator. Only the administrator has access to all documents held by that company within its own platform. Accordingly a multiple account, multiple administrator system can be set up on a server which provides each account holder with a discrete space on the server and access to this space is under the exclusive control of that company's own administrator independent of any global administrator overseeing the server.

The party establishing or initiating the server space provides a common project identifier to all parties which acts as the linkage between the multiple discrete platforms working within the same common project workspace.

In order for the efficient management of documents the server may be provided with basic tools to allow documents to be managed and filed in a uniform manner for the entire project. Accordingly documents may be uploaded to the server in a uniform manner thus enabling all parties to easily locate relevant documents.

Any user who wishes to upload information to the server firstly selects the files it wishes to upload from its own digital files or other external sources such as a digital camera or scanner. The user then selects the parties to whom the document should be sent from within its own distribution list or distribution list provided by the developer, specifying either single or multiple recipients. Once the recipients are selected the user can then upload the files to the server. File attributes may be assigned to the file being uploaded to enable the file to be referenced easily as well as located via a system search engine.

At the server the file is distributed according to the distribution list selected by the source or sender of the file. Each individual recipient will firstly receive a message in their own “What's New” window to inform them of the received file. Furthermore, the file will be directed to a predefined inbox contained within that companies' filing system. The file will reside in the inbox until such time as all the specified recipients have opened the file, before which time the file cannot be moved, deleted, modified or archived.

Upon being opened by all recipients, the file can be managed by the users with the necessary access rights. Thus for example if a file has been distributed to company A, B and D, once the recipients in company A have opened the file, the file can be stored by company A in any manner it sees fit.

Users may also distribute the file internally within the entity itself and may set time criteria for the handling of that file. Thus for example a file may be distributed internally with instructions that the recipients provide comments within a predefined time limit.

For internal circulation of any files which have been received from other parties the user selects the files from those which have been uploaded to the system and then selects the recipients. In this case the recipients will be people within the company. User groups can be defined so that selection of the same multiple users for regular distribution does not have to be done separately on each occasion. The circulation can be performed for information only for which no reply is required or for actioning for which a response time limit is set by the sender. A message may be sent along with the file for instructions to the recipient. Any comments/feedback received are maintained within the users own discrete system on the platform and are not available for any other users to access. Hence all internal comments/feedback can be assured of confidentiality.

Each user has access to separate internal circulation log which maintain records of original circulation sent or received along with any subsequently linked responses or further circulation, allowing the history of the circulation to be logged and monitored. Should responses not be received within the original time limit set, a message will concurrently be generated to the sender and recipient, via the What's New function, informing them so and will continue to do so on a daily basis until a response is sent. In this manner it is possible to ensure all the relevant parties within an organisation receive and action the document in an efficient and timely manner.

This avoids the need for a sender to send the document or data to multiple in addition to uploading the document/data to the server.

By selecting the recipients to whom a file should be sent the user can control who has access to that information and thus the user can achieve selective distribution over a common access platform.

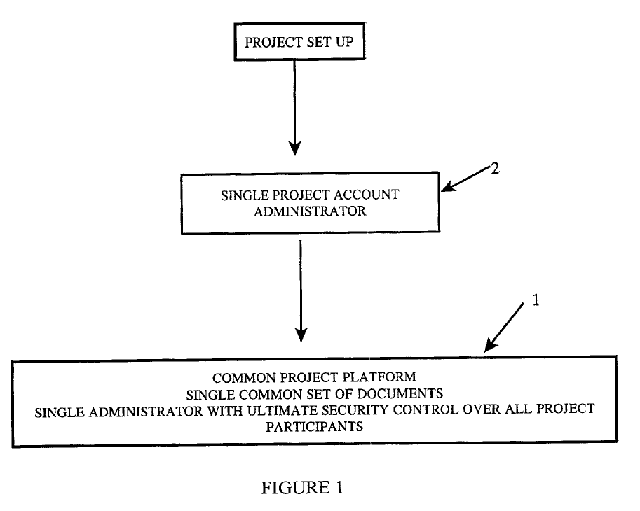

FIG. 1 is a flowchart of a typical common access platform project hosting website with a single account, single administrator.

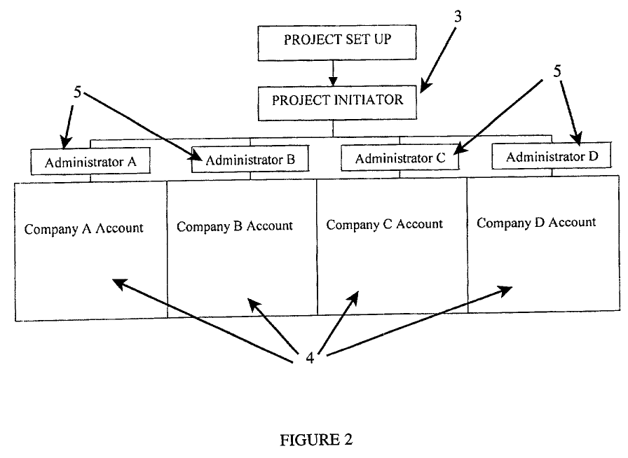

FIG. 2 is a flowchart of a multiple account, multiple administrator platform project hosting website.

In the single account single administrator type platform the developer will set up a site (1) on a platform which may be provided by a third party provider. The entire site will be administered by a single administrator (2) who will have responsibility for the integrity of the entire site. All parties to the project will have access to the site and will be able to upload and download data to and from the platform. The administrator will retain control of who has access to which data and whether this data can be modified and or deleted.

In the multiple account, multiple administrator type platform the developer sets up the project (3). The various parties to the project then contract with the service provider and are allocated their own space on the server (4). Each company can then appoint its own administrator (5) to administer that company's site. If company A wishes to send certain data to company B and company C then it will select the data to be sent from its own files and will then upload this to account for company B and company C on the server (4). Once the data is received by company B and company C they are then free to deal with the data as they see fit. Company D will not receive the data and thus will be unaware of the contents of the data.

Each party to the project is thus able to hold information discretely from all other parties in the project, on its own platform and can have absolute control of who has access to its data.

The method of selective file distribution disclosed herein can be applied to any industry where there are multiple parties involved. The use of the construction industry herein is merely an example of the methodology in use and is used for illustrative purposes only.

1. A system for the distribution of electronic documentation or information in the form of files and or data to multiple participants in a project hosting site across the Internet using a multiple account, multiple administrator platform which is maintained on a server and which server is managed and administered by an administrator overseeing the entire server and wherein a sender can distribute its files and or data to all such participants in the project or selectively distribute files and or data to selected participants in the project.

2. A system as claimed in claim 1 above wherein each participant is provided with its own discrete platform on the server and wherein each such individual platform may be linked to other platforms on the server and wherein each individual participant can control access to its own platform on the server by its own administrator who is independent of the administrator overseeing the server.

3. A system as claimed in claim 1 wherein any participant can upload electronic files and or data from its own computer and or directly input and upload data to all participants in the project by addressing and sending the files and or data to all participants

4. A system as claimed in claim 1 wherein any participant can upload electronic files and or data from its own computer and or directly input and upload data to selective participants by addressing and sending the files and or data to those selected participants only.

5. A system as claimed in 3 above wherein each participant selected by the sender receives its own copy of the file which is inaccessible by any other participant to the project having access to the server and whereby the said participant may freely deal with the file received.
